(19) United States
(12) Patent Application Publication
(10) Pub. No.: US 2022/0408368 A1
(43) Pub. Date: Dec. 22, 2022

(54) METHOD OF TPMI GROUPING FOR MODE 2 OPERATION OF 4-TX CAPABILITY 3 PARTIAL COHERENT UES

(71) Applicants: NTT DOCOMO, INC., Tokyo (JP); DOCOMO INNOVATIONS, INC., Palo Alto, CA (US)

(72) Inventors: Nadisanka Rupasinghe, Palo Alto, CA (US); Masaya Okamura, Chiyoda-Ku, Tokyo (JP); Yuki Matsumura, Tokyo (JP); Satoshi Nagata, Chiyoda-ku, Tokyo (JP)

(73) Assignee: NTT DOCOMO, INC., Tokyo (JP)

(21) Appl. No.: 17/775,132

(22) PCT Filed: Nov. 5, 2020
(86) PCT No.: PCT/US2020/059170

§ 371 Date: May 6, 2022

Related U.S. Application Data
(60) Provisional application No. 62/932,228, filed on Nov. 7, 2019.

(51) Int. Cl. H04W 52/14; H04W 52/30

(52) U.S. Cl. CPC H04W 52/146; H04W 52/30

(57) ABSTRACT

A method of transmission precoding matrix indicator (TPMI) grouping includes identifying, all TPMI groups to achieve uplink (UL) full power for Capability 3 partial coherent user equipment (UE) with 4-Tx ports with a Mode 2 operation.

### TECHNICAL FIELD

One or more embodiments disclosed herein relate to transmission precoding matrix indicator (TPMI) grouping for User Equipment (UE).

### BACKGROUND ART

New Radio (NR) supports Uplink (UL) multi-antenna Physical Uplink Shared Channel (PUSCH) transmission up to 4 layers. A UE can be configured in two different modes for multi-antenna PUSCH transmission.

A codebook based mode may be typically used when UL/Downlink (DL) reciprocity does not hold. In the codebook based mode, a network may inform TPMI, a scheduling request indicator (SRI) and a rank of the channel. Coherence capability between different ports is important for codebook based PUSCH transmission. Note that the coherence capability defines to what extend the relative phases between the signals transmitted on different ports can be controlled [1]. The UE needs to report its capability to the NW side which includes, among other things, number of supporting ports, coherence capability of antenna ports, etc.

In a non-codebook based mode, channel reciprocity may be assumed. In particular, in non-codebook based mode NW does not configure a TPMI for PUSCH transmission.

The coherence capability of an UE is defined under three categories: full coherent, partial coherent, and non-coherent.

Based on reported UE capability, gNodeB (gNB) assigns only the relevant codewords (using TPMI) from the codebooks defined in [2].

FIG. 1 shows a UL codebooks for a case of two antenna ports. FIG. 2 shows a single-layer UL codebook for four antenna ports.

In NR Re1.15, non/partial-coherent capable UE can't transmit codebook based PUSCH with full power due to two main reasons. One reason is that, TPMI codebook subsets are pre-associated with the coherent capability of UEs as shown in a table of FIG. 3. For example, a UE with 4 non-coherent antenna ports is allowed only to use following TPMIs: [1 0 0 0]^{T}, [0,1, 0, 0]^{T}, [0, 0, 1, 0]^{T} and [0, 0, 0, 1]^{T}. Now, assume that the UE has 4 PAs, each with 20 dBm output rating. Due to the previously mentioned TPMI allocation, the UE may not be able achieve full power even by considering cyclic delay diversity (CDD).

The other reason why NR Re1.15, non/partial-coherent capable UE can't transmit codebook based PUSCH with full power is because of the way UL power scaling is achieved. In particular, as per TS 38.213, Sec. 7.1, UL Tx power is scaled according to the ratio of number of PUSCH Tx ports to the number of configured ports. Then, a UE configured with a TPMI having zero entries cannot transmit with full Tx power even if it has full rated power amplifiers.

For example, Consider a UE with 2 non-coherent antenna ports is assigned the precoder [1,0]^{T}. Here, the first antenna port is assigned \hat{P}_{PUSCH}/2 transmit power (linear value) to transmit PUSCH. Thus, for a class-3 UE that is powered by 2 PAs, each with a 23 dBm output rating, the maximum transmit power with precoder [1,0] ^{T} is 3 dB below the maximum possible power the UE can transmit.

### CITATION LIST

Non-Patent References

[Non-Patent Reference 1] Erik Dahlman, Stefan Parkvall, Johan Skold. “5G NR: The Next Generation Wireless Access Technology.”

[Non-Patent Reference 2] 3GPP, TS 38.211, “5G; NR; Physical channels and modulation”

### SUMMARY OF INVENTION

One or more embodiments provide a method of transmission precoding matrix indicator (TPMI) grouping includes identifying, all TPMI groups to achieve uplink (UL) full power for Capability 3 partial coherent user equipment (UE) with 4-Tx ports with a Mode 2 operation.

One or more embodiments provide a method of TPMI grouping that includes identifying only necessary TPMI groups to achieve UL full power for Capability 3 partial coherent UE with 4-Tx ports with Mode 2 operation.

### BRIEF DESCRIPTION OF DRAWINGS

FIG. 1 shows a UL codebooks for a case of two antenna ports.

FIG. 2 shows a single-layer UL codebook for four antenna ports.

FIG. 3 shows a table indicating precoding matrix W for single-layer transmission using four antenna ports with transform precoding enabled.

FIG. 4 shows a wireless communications system according to one or more embodiments.

FIG. 5 shows a Power Amplifier (PA) architecture of UE having 4-Tx antennas.

FIG. 6 shows a diagram of Mode 1 according to one or more embodiments.

FIG. 7 shows a diagram of Mode 2 according to one or more embodiments.

FIGS. 8A-8D show 4-Tx codebooks of Rel. 15 for RI being 1, 2, 3, and 4, respectively, according to one or more embodiments.

FIGS. 9A-9G show examples of Option 1 in Proposal 1 according to one or more embodiments.

FIGS. 10A-10G show examples of Option 2 in Proposal 1 according to one or more embodiments.

FIG. 11 shows a table indicating TPMIs groups supporting UL full power Tx for 4-Tx Cap.3 partial coherent UE according to one or more embodiments.

FIG. 11 shows a table indicating TPMIs groups supporting UL full power Tx for 4-Tx Cap.3 partial coherent UE according to one or more embodiments.

FIG. 12 shows a table of simplified TPMI groups supporting UL full power for 4-Tx Cap.3, partial coherent UE according to one or more embodiments.

FIG. 13 shows a table of simplified TPMI groups supporting UL full power for 4-Tx Capability 3, partial coherent UE according to one or more embodiments.

FIG. 14 is a diagram showing a schematic configuration of a BS according to embodiments of the present invention.

FIG. 15 is a diagram showing a schematic configuration of a UE according to embodiments of the present invention.

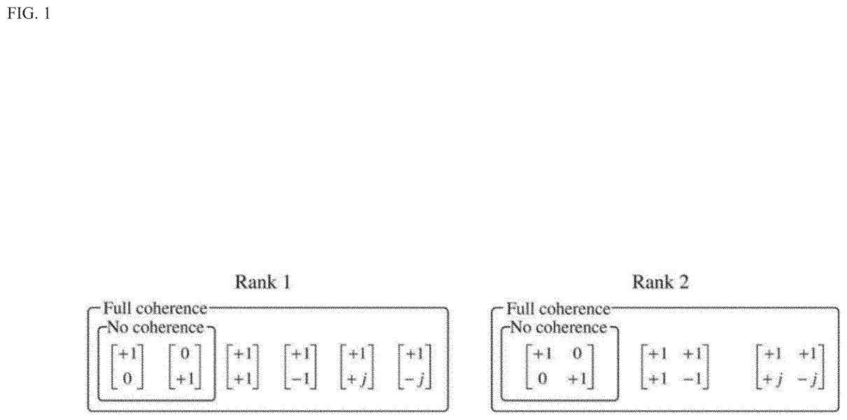

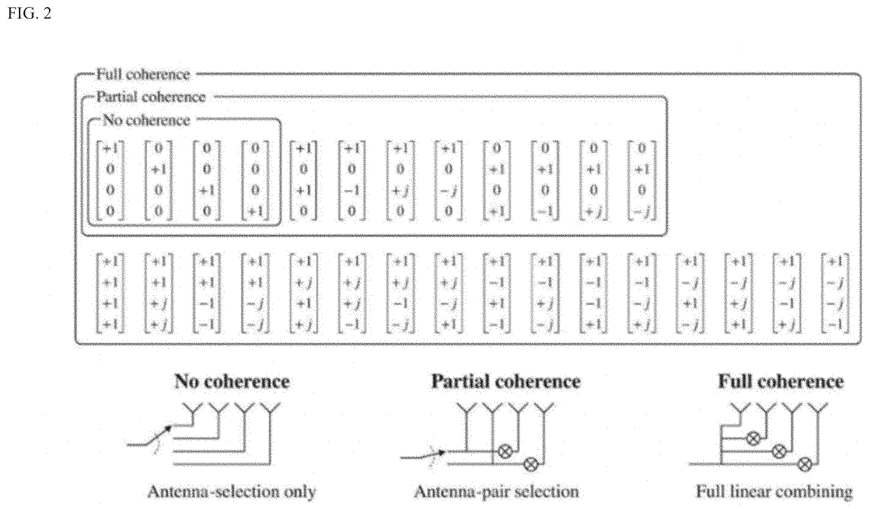

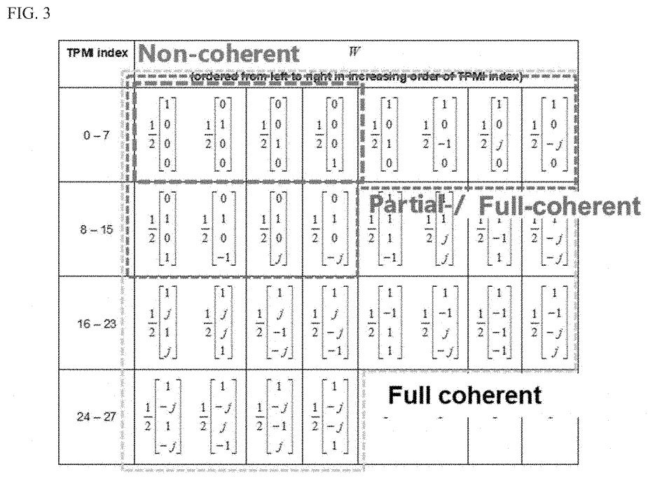

### DESCRIPTION OF EMBODIMENTS

Embodiments of the present invention will be described in detail below with reference to the drawings. Like elements in the various figures are denoted by like reference numerals for consistency.

In the following description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

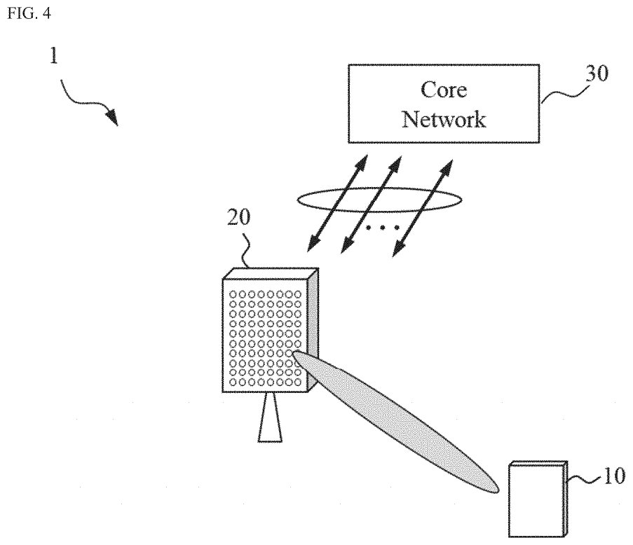

FIG. 4 is a wireless communications system 1 according to one or more embodiments. The wireless communication system 1 includes a user equipment (UE) 10, a base station (BS) 20, and a core network 30. The wireless communication system 1 may be a New Radio (NR) system. The wireless communication system 1 is not limited to the specific configurations described herein and may be any type of wireless communication system such as an LTE/LTE-Advanced (LTE-A) system.

The BS 20 may communicate UL and DL signals with the UE 10 in a cell of the BS 20. The DL and UL signals may include control information and user data. The BS 20 may communicate DL and UL signals with the core network 30 through backhaul links 31. The BS 20 may be gNodeB (gNB).

The BS 20 includes antennas, a communication interface to communicate with an adjacent BS 20 (for example, X2 interface), a communication interface to communicate with the core network 30 (for example, S1 interface), and a CPU (Central Processing Unit) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous BSs 20 may be disposed so as to cover a broader service area of the wireless communication system 1.

The UE 10 may communicate DL and UL signals that include control information and user data with the BS 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

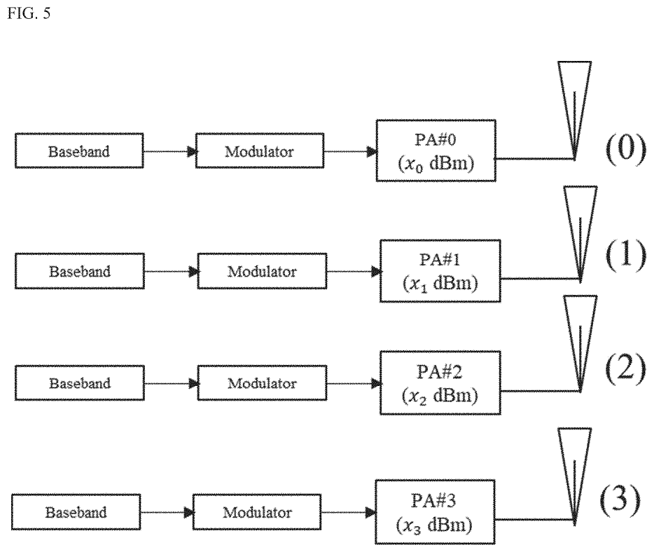

FIG. 5 shows a Power Amplifier (PA) architecture of the UE 10 having 4-Tx antennas. The UE capability may be defined as follows:

Capability 1: x_0=x_1=x_2=x_3=23 dBM;

Capability 2: xᵢ<23 dBm, i ∈ {0, 1, 2, 3}; and

Capability 3: xᵢ=23 dBm; xⱼ<23 dBm; i≠j; i,j ∈ {0, 1, 2, 3}.

For example, the UE 10 having Capability 1 may be referred to as Capability 1 UE.

A coherent capability between antenna ports may be categorized into full coherent where all antenna ports are coherent, partial coherent where antenna ports {0, 2} and {1, 3} are coherent, or non-coherent where none of the ports are coherent.

Capability 1, 2 or 3 UE may be full, partial or non-coherent.

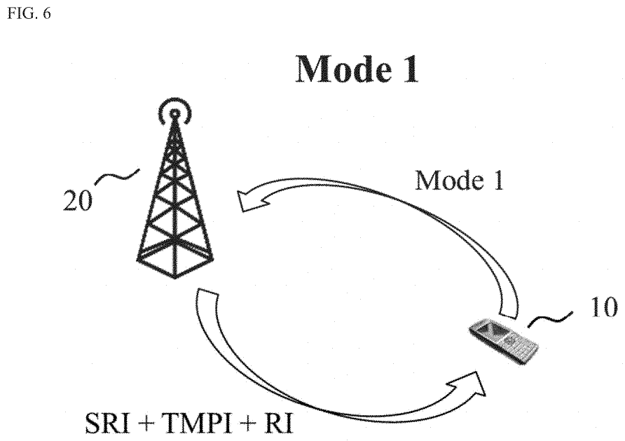

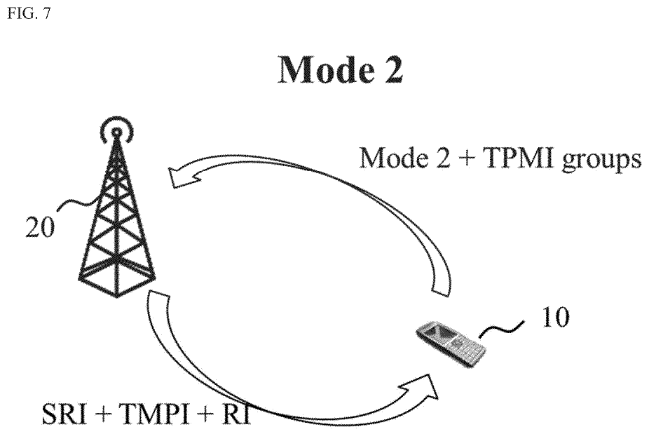

There are two modes of operation to achieve UL full power with NR Rel. 16 as shown in FIGS. 6 and 7.

FIG. 6 shows a diagram of Mode 1 according to one or more embodiments. In Mode 1, the TMPI may be derived from a new codebook subset and apply Rel. 15 power scaling. Both Capability 2 and Capability 3 UEs may signal. The sounding reference signal (SRS) resources have the same number of SRS ports.

FIG. 7 shows a diagram of Mode 2 according to one or more embodiments. In Mode 2, the TMPI may be selected from reported TMPIs. Both Capability 2 and Capability 3 UEs may signal. The SRS resources have different number of SRS ports. The SRS ports are related to activated Tx chains. The SRI may be used to activate different numbers of SRS ports. Power scaling factor is 1 if indicated TPMI is from reported TMPI group.

In one or more embodiments, the number of PA Architectures for 4-Tx Capability 3 UE will be described below. Xᵢ may indicate rated power of i^{th} PA.

All combinations without any restrictions include Capabilities 1, 2 and 3 UEs.

[X₁X₂X₃X₄] where Xᵢ ∈ {23, 20, 17}

3×3×3×3=81 combinations

For Capability 3 UE, there should be at least one PA with 23 dBm. Therefore, all PA architectures without having at least one 23 dBm PA (Capability 2 UEs) may need to be removed.

[X₁X₂X₃X₄] where Xᵢ ∈ {20, 17}

2×2×2×2=16 combinations

[23 23 23 23] combination may need to be removed since this is Cap. 1 UE

Thus, the total number of PA architectures for 4-Tx Capability 3 UE may be 81−16−1=64.

Mode 2 requires UE to signal TPMI groups which can support UL full power. For 4-Tx, capability 3 UE, 64 different PA architectures are possible. Each of the PA architectures supports full power for different ranks with different TPMIs. It requires high signaling overhead to explicitly report the TPMIs.

Accordingly, it may be required to group common TPMIs together which provide UL full power by analyzing all PA architectures of 4-Tx, capability 3 partial-coherent UEs. Further, it may be required to reduce the number of groups by exploiting relations between TMPI groups.

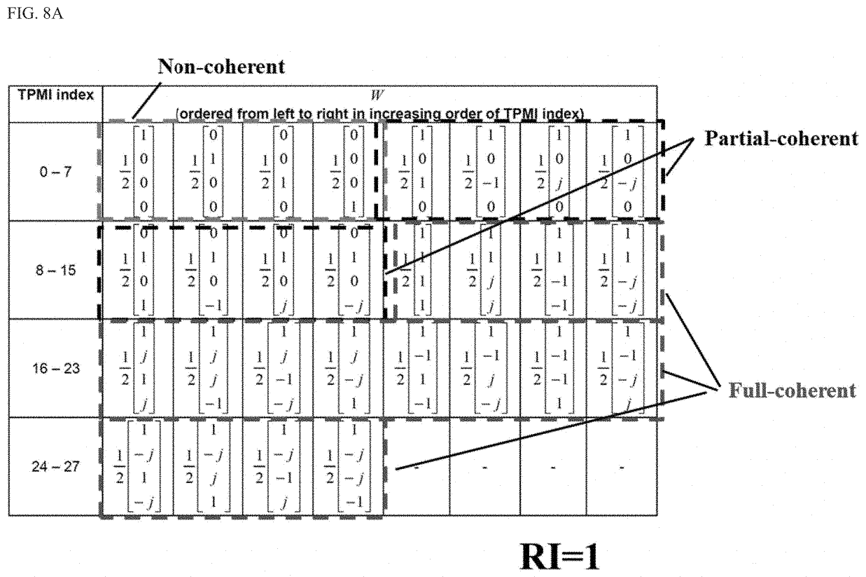

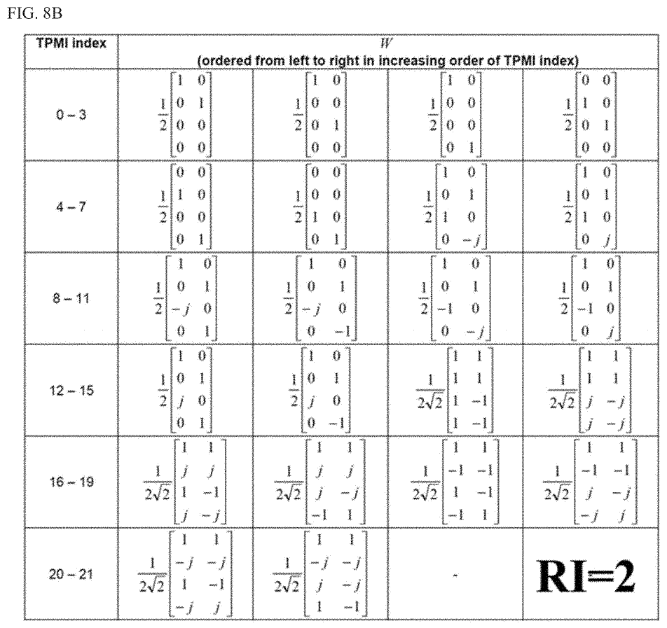

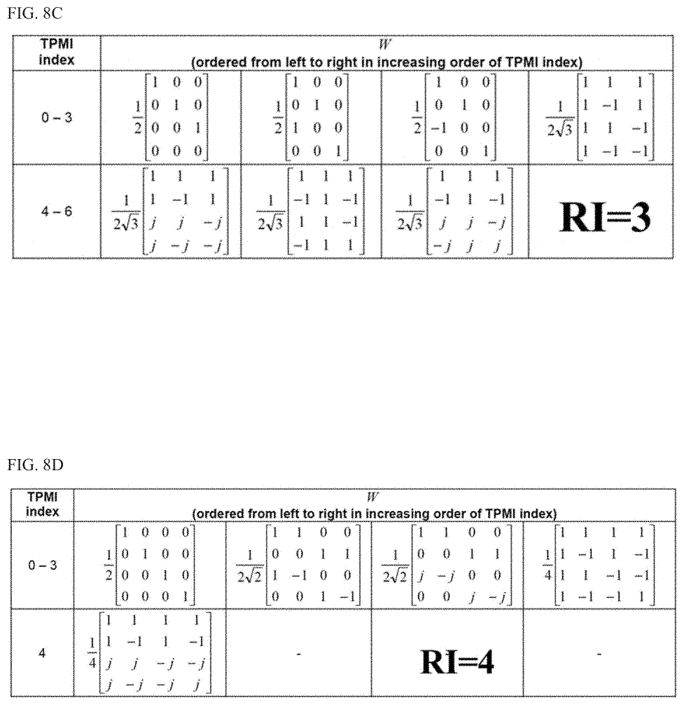

FIGS. 8A-8D show 4-Tx codebooks of Rel. 15 for RI being 1, 2, 3, and 4, respectively, according to one or more embodiments. Rel. 15 TPMIs may be used for identifying TPMI groups.

Proposal 1: TPMI Grouping for 4-Tx Capability 3 Partial Coherent UEs

TPMIs can be grouped as follows which is common to both Option1 and Option 2 in Proposal 1.

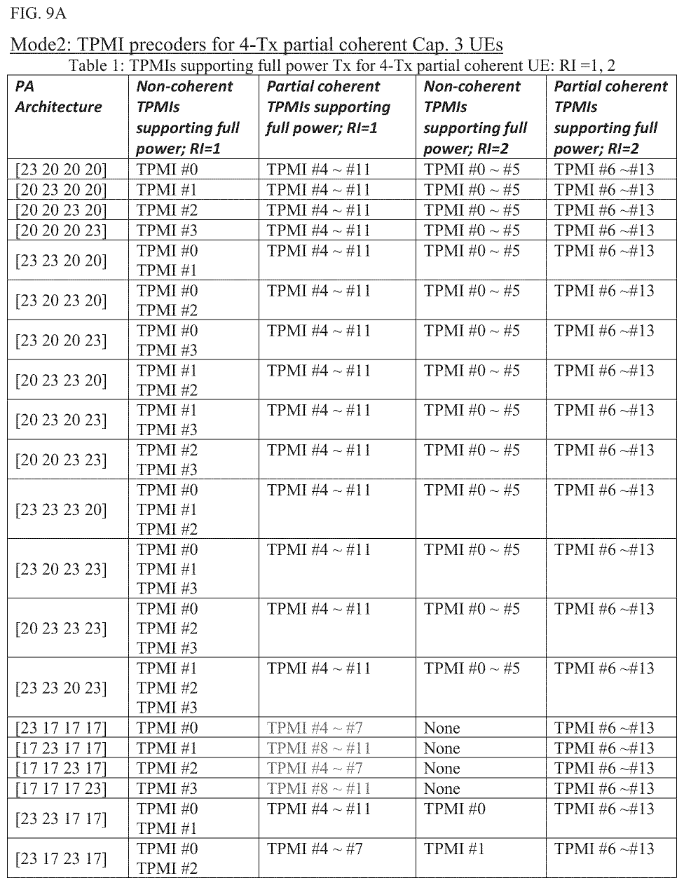

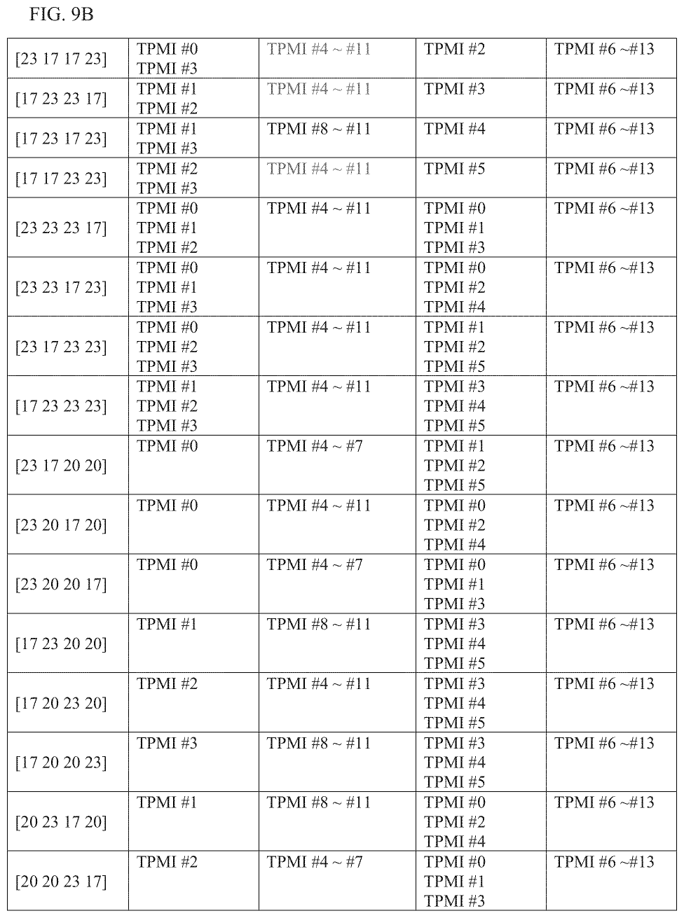

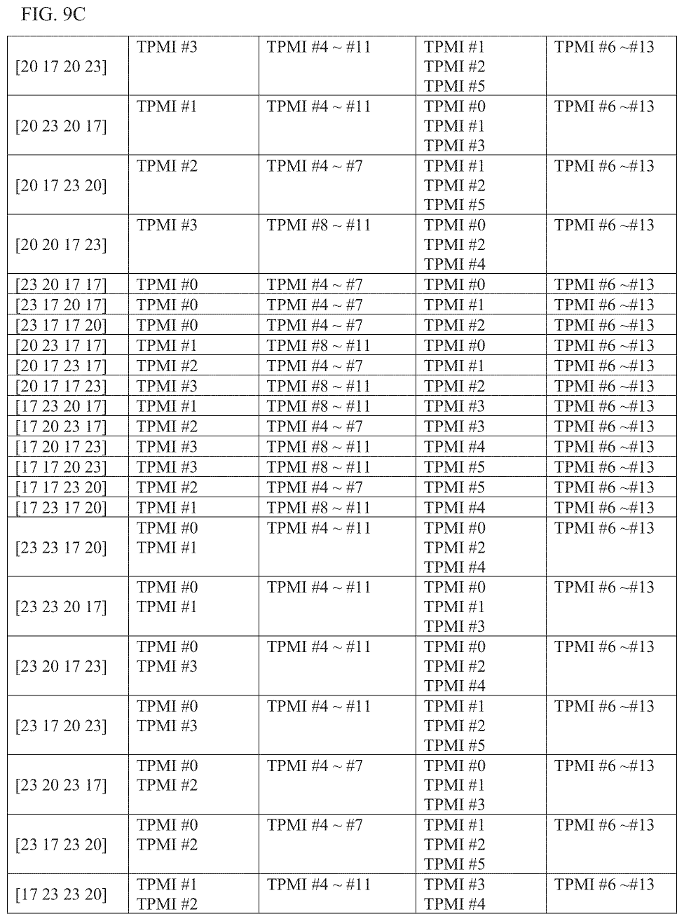

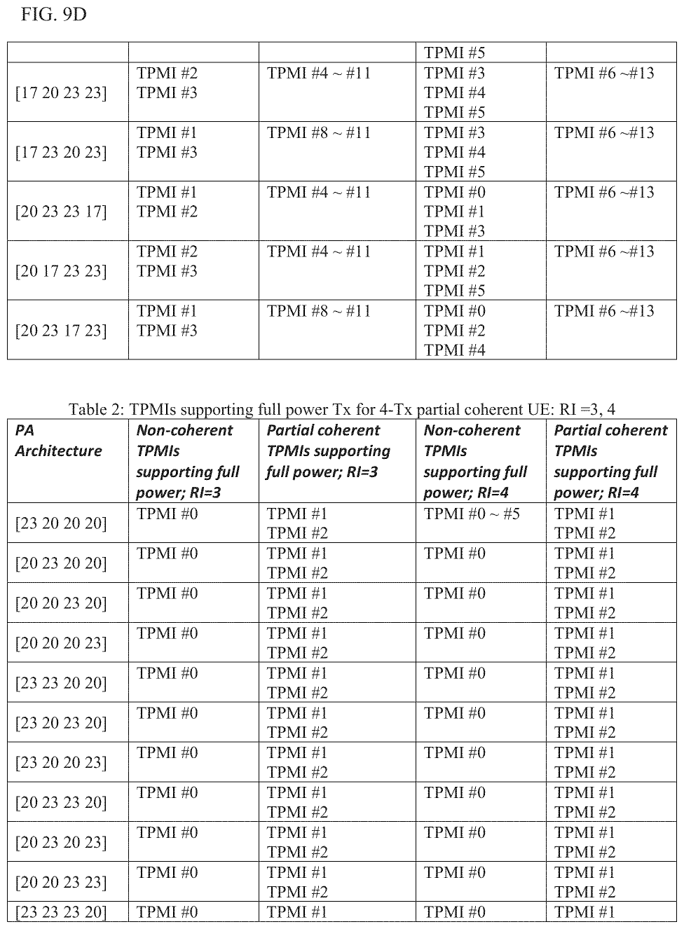

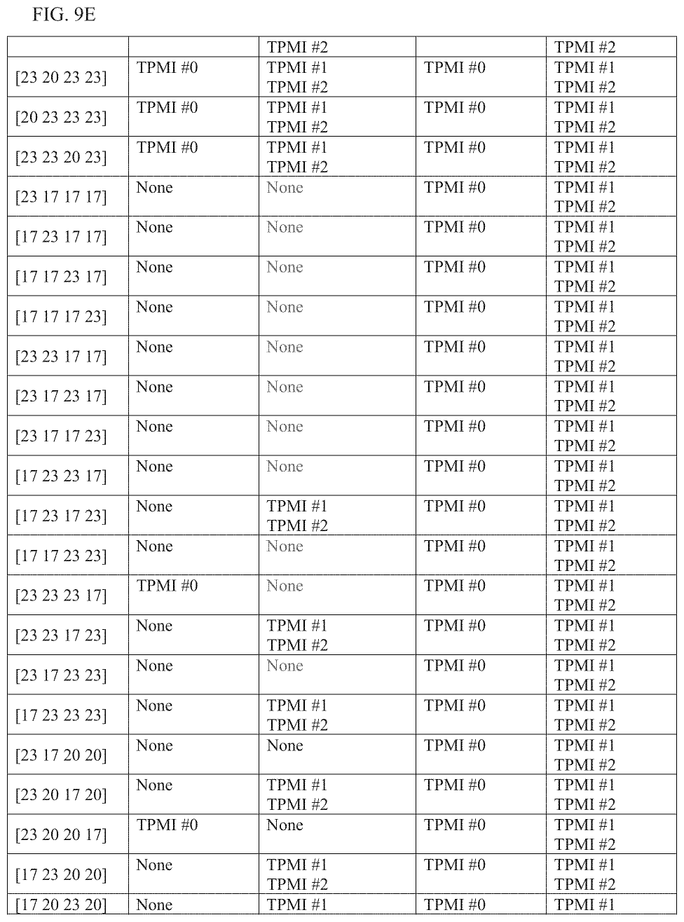

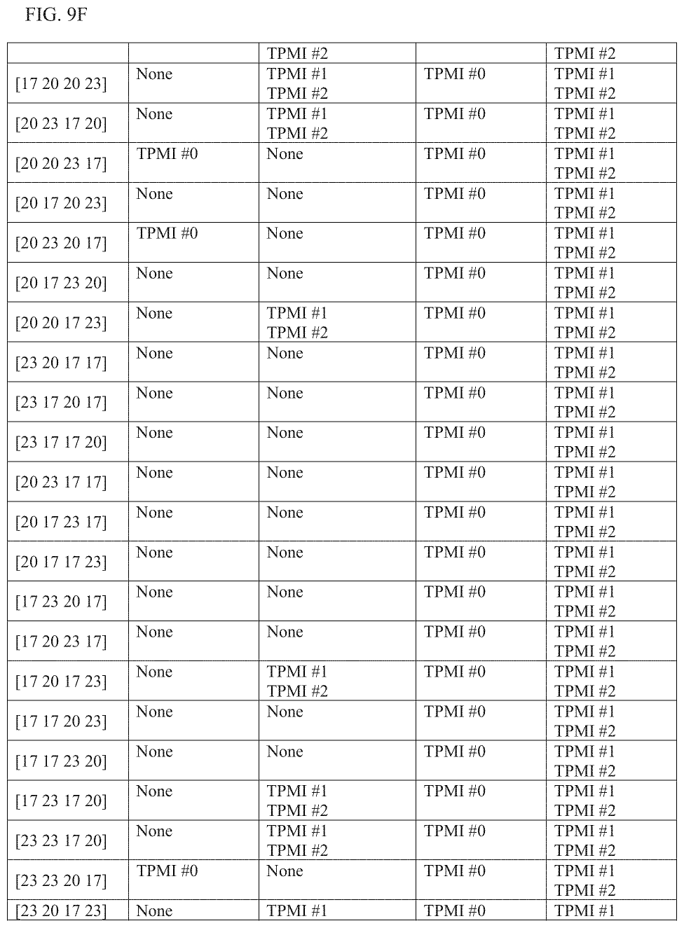

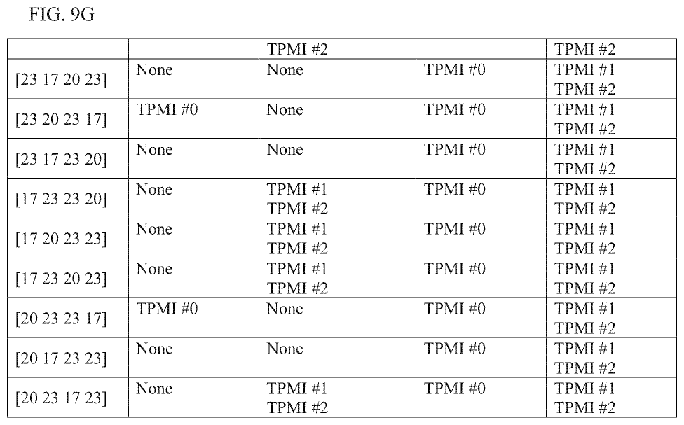

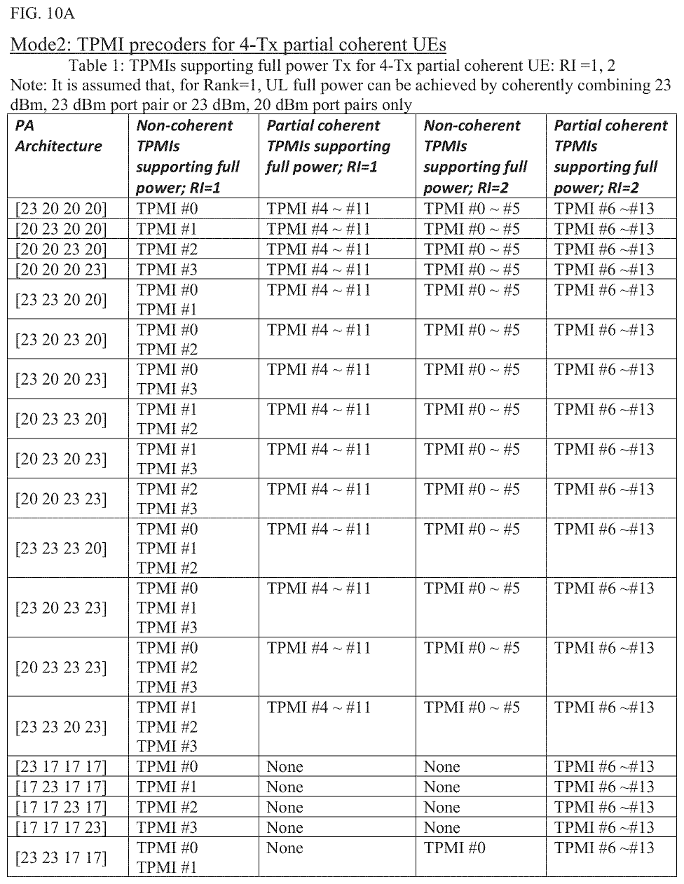

In Option1, assuming for Rank=1, UL full power can be achieved by coherently combining 23 dBm, 23 dBm port pair or 23 dBm, 20 dBm port pair or 23 dBm, 17 dBm port pair, TPMIs supporting UL full power for Rank=1, 2, 3, 4 of 64 different PA architectures are captured in FIGS. 9A-9G, ‘Full_Pwr_TPMIs_[Mode2]_[Cap3]_[PartialCoherent].’

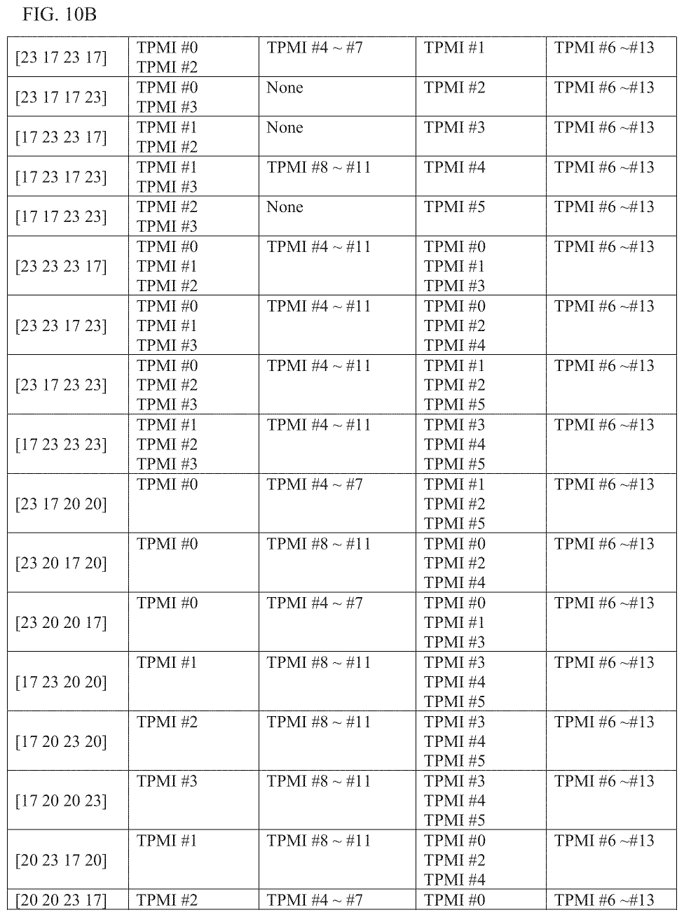

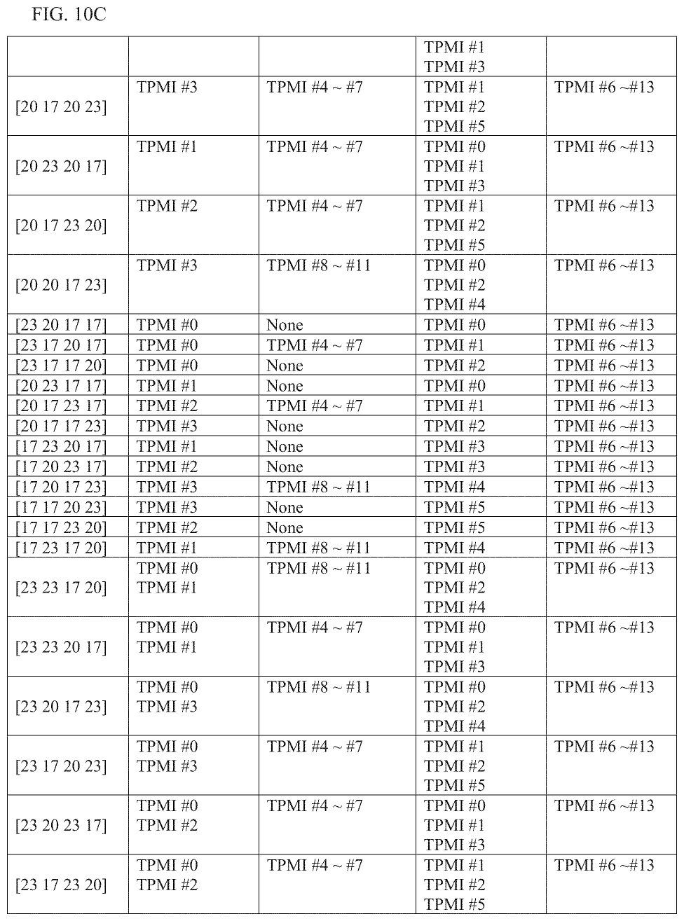

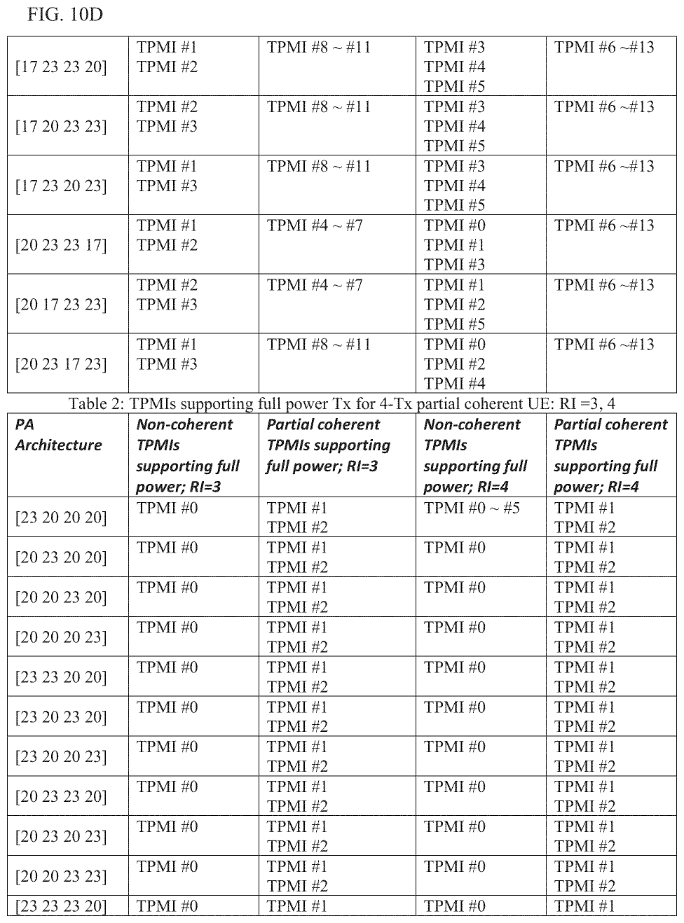

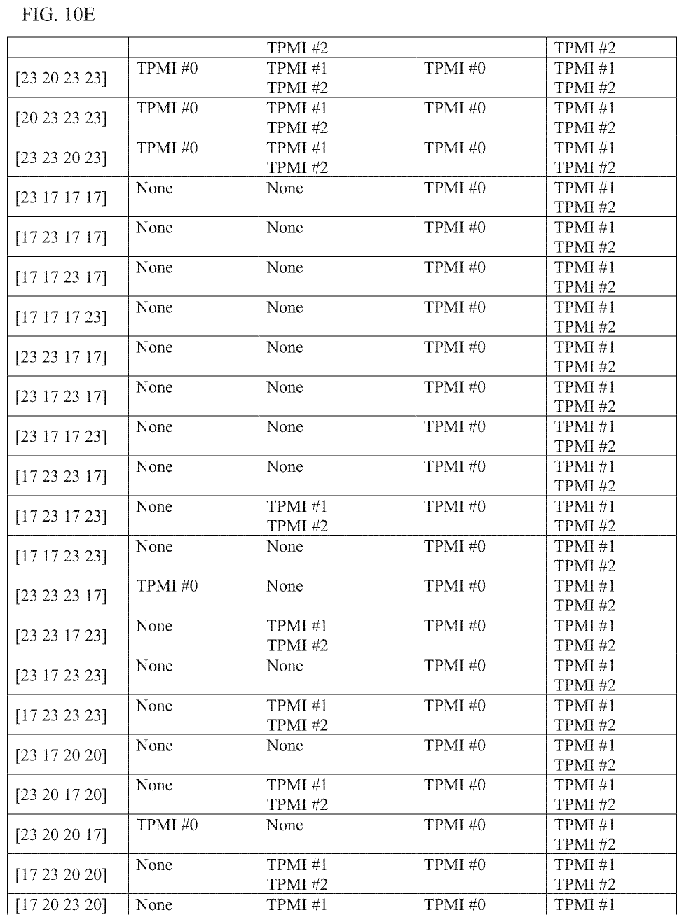

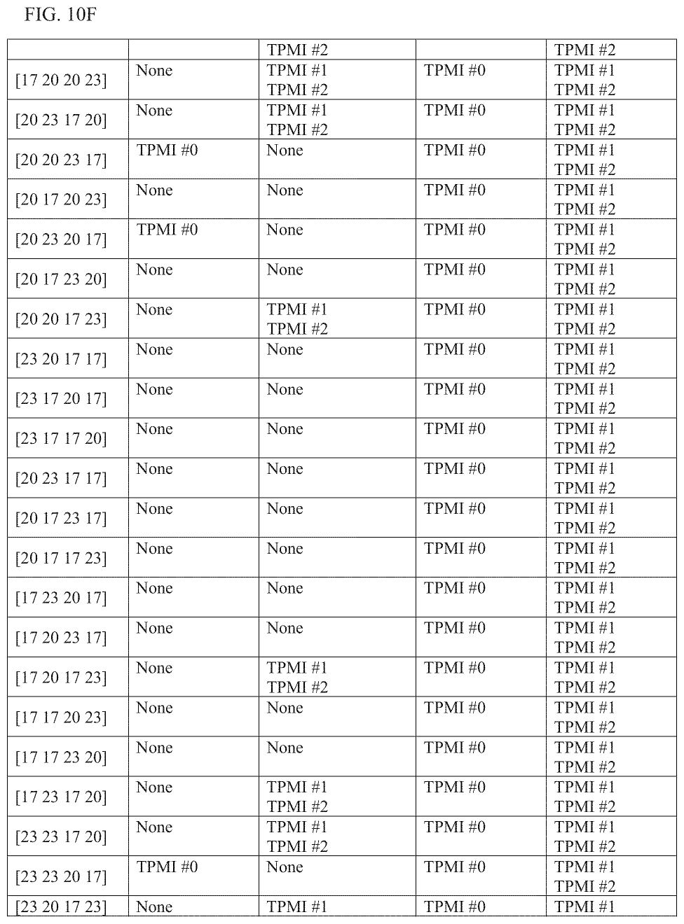

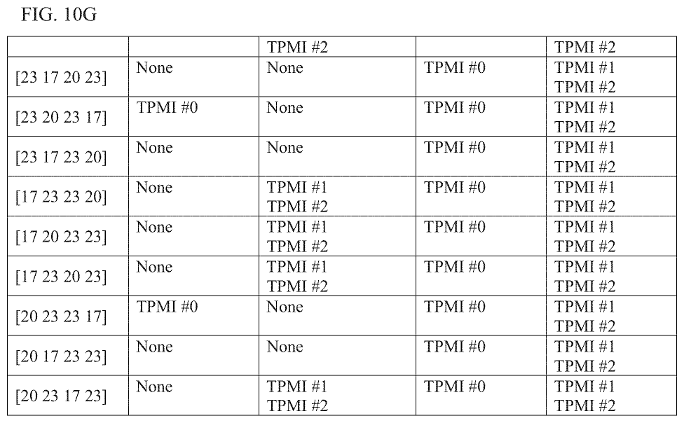

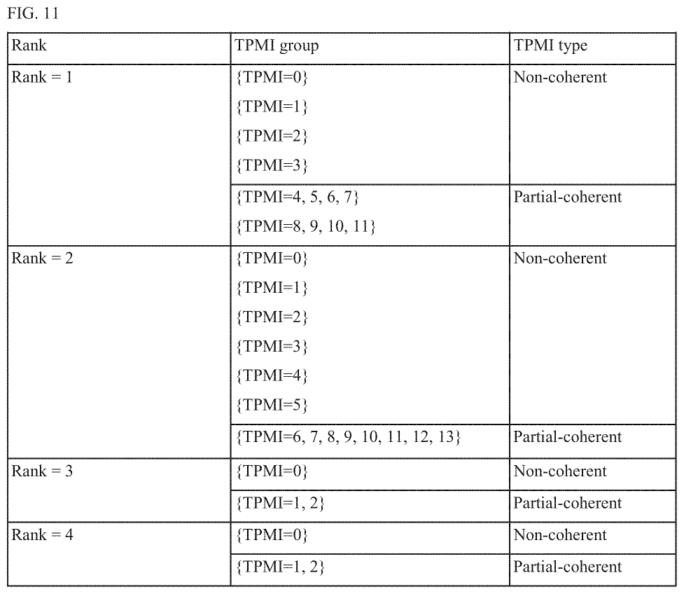

In Option2, assuming, for Rank=1, UL full power can be achieved by coherently combining 23 dBm and 23 dBm port pairs only, TPMIs supporting UL full power for Rank=1, 2, 3, 4 of 64 different PA architectures are captured in FIGS. 10A-10G, ‘Full_Pwr_TPMIs_[Mode2]_[Cap3]_[PartialCoherent]_Variation.’

FIG. 11 shows a table indicating TPMIs groups supporting UL full power Tx for 4-Tx Cap.3 partial coherent UE according to one or more embodiments. In Options 1 and 2 in Proposal 1, TPMIs may be grouped as shown in FIG. 11.

Proposal 2: Rank=1, Partial-coherent TPMI groups

Proposal 2 may be applicable only for Option 1 in Proposal 1.

In a first example of Proposal 2, TPMI #0 can provide full power with PA architecture [23 X₂X₃X₄], Xᵢ ∈ {23, 20, 17}. Then, TPMIs #4-#7 also provide full power. This can be given as,

If precoder

$$[ \begin{matrix}1 \\ 0 \\ 0 \\ 0\end{matrix} ]$$

provides full power,

$$[ \begin{matrix}1 \\ 0 \\ 1 \\ 0\end{matrix} ] , [ \begin{matrix}1 \\ 0 \\ - 1 \\ 0\end{matrix} ] , [ \begin{matrix}1 \\ 0 \\ j \\ 0\end{matrix} ] , [ \begin{matrix}1 \\ 0 \\ - j \\ 0\end{matrix} ]$$

precoders also provide full power.

Similarly, when TPMI #2 provides full power with PA architecture [23 X₂X₃X₄], Xᵢ ∈ {23, 20, 17}, then TPMIs #4-#7 also provide full power.

In a second example of Proposal 2, TPMI #1 can provide full power with PA architecture [X₁23 X₂ X₃], Xᵢ ∈ {23, 20, 17}. Then TPMIs #8-#11 also provide full power. This can be given as,

If precoder

$$[ \begin{matrix}0 \\ 1 \\ 0 \\ 0\end{matrix} ]$$

provides full power,

$$[ \begin{matrix}0 \\ 1 \\ 0 \\ 1\end{matrix} ] , [ \begin{matrix}0 \\ 1 \\ 0 \\ - 1\end{matrix} ] , [ \begin{matrix}0 \\ 1 \\ 0 \\ j\end{matrix} ] , [ \begin{matrix}0 \\ 1 \\ 0 \\ - j\end{matrix} ]$$

precoders also provide full power.

Similarly, when TPMI #3 provides full power with PA architecture [X₁X₂X₃23], Xᵢ ∈ {23, 20, 17}, then TPMIs #8-#11 also provide full power.

Thus, no need to explicitly capture partial-coherent TPMI groups for Rank=1 in the table of FIG. 11. This can implicitly be derived using non-coherent TPMI groups for Rank=1.

Proposal 3: Rank=3, Non/partial-coherent TPMI group

In Proposal 3, when a PA architecture provides full power for Rank=2 with non/partial-coherent TPMI groups, {TPMI=0} and {TPMI=1} in the table of FIG. 11, then, the PA architecture provides full power for Rank=3 with non/partial-coherent TPMI group, {TPMI=0} in the table of FIG. 11 and vice versa. This can be given as,

If precoders,

$$[ \begin{matrix}1 & 0 \\ 0 & 1 \\ 0 & 0 \\ 0 & 0\end{matrix} ] , [ \begin{matrix}1 & 0 \\ 0 & 0 \\ 0 & 1 \\ 0 & 0\end{matrix} ]$$

can provide full power for Rank=2, then, precoder

$$[ \begin{matrix}1 & 0 & 0 \\ 0 & 1 & 0 \\ 0 & 0 & 1 \\ 0 & 0 & 0\end{matrix} ]$$

provides full power for Rank=3.

These 3 TPMIs can be grouped together to achieve full power transmission with Rank=2 and Rank=3.

On the other hand, there may be no need to explicitly capture if non/partial-coherent, {TPMI=0} for Rank=3 in the table of FIG. 11 since this can implicitly be derived using non-coherent TPMI groups for Rank=2.

Proposal 4: Rank=3, partial-coherent TPMI group

In Proposal 4, when a PA architecture can provide full power for Rank=2 with non-coherent TPMI group, {TPMI=4} in the table of FIG. 11, then, the PA architecture provides full power for Rank=3 with partial-coherent TPMI group {TPMI=1, 2} in the table of FIG. 11 and vice versa. This can be given as,

If precoder,

$$[ \begin{matrix}0 & 0 \\ 1 & 0 \\ 0 & 0 \\ 0 & 1\end{matrix} ]$$

can provide full power for Rank=2, then, precoders

$$[ \begin{matrix}1 & 0 & 0 \\ 0 & 1 & 0 \\ 1 & 0 & 0 \\ 0 & 0 & 1\end{matrix} ] , [ \begin{matrix}1 & 0 & 0 \\ 0 & 1 & 0 \\ - 1 & 0 & 0 \\ 0 & 0 & 1\end{matrix} ]$$

provide full power for Rank=3.

Thus, no need to explicitly capture partial-coherent TPMI group, {TPMI=1, 2} for Rank=3 in the table of FIG. 11. This can implicitly be derived using non-coherent TPMI groups for Rank=2.

Proposal 5: Modified TMPI Grouping applied to Option 1 in Proposal 1

In Proposal 5 applied to Option 1 in Proposal 1, all 4-Tx partial-coherent, Capability 3 PA architectures provide full power with partial-coherent TPMI group {TPMI=6, 7, 8, 9, 10, 11, 12, 13} for Rank=2 in the table of FIG. 11.

All 4-Tx partial-coherent, Capability 3 PA architectures provide full power with partial-coherent TPMI groups {TPMI=0} and {TPMI=1, 2} for Rank=4 in the table of FIG. 11.

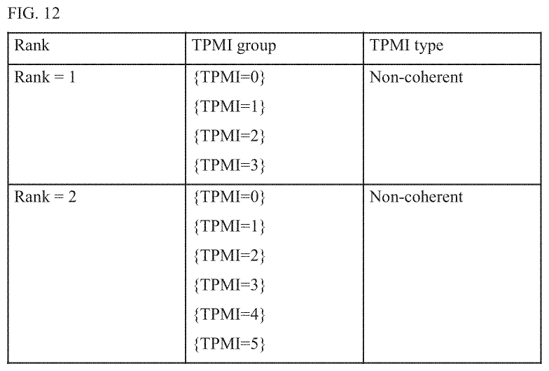

FIG. 12 shows a table of simplified TPMI groups supporting UL full power for 4-Tx Cap.3, partial coherent UE according to one or more embodiments. The table of FIG. 12 is obtained by applying a method of Proposal 5. Thus, the table of FIG. 11 may be simplified based on Proposals 2, 3, or 4.

Proposal 5: Modified TMPI Grouping applied to Opt.2 in Proposal 1

In Proposal 5 applied to Option 2 in Proposal 1, all 4-Tx partial-coherent, Capability 3 PA architectures provide full power with partial-coherent TPMI group {TPMI=6, 7, 8, 9, 10, 11, 12, 13} for Rank=2 in the table of FIG. 11.

All 4-Tx partial-coherent, Cap. 3 PA architectures provide full power with partial-coherent TPMI groups {TPMI=0} and {TPMI=1, 2} for Rank=4 in the table of FIG. 11.

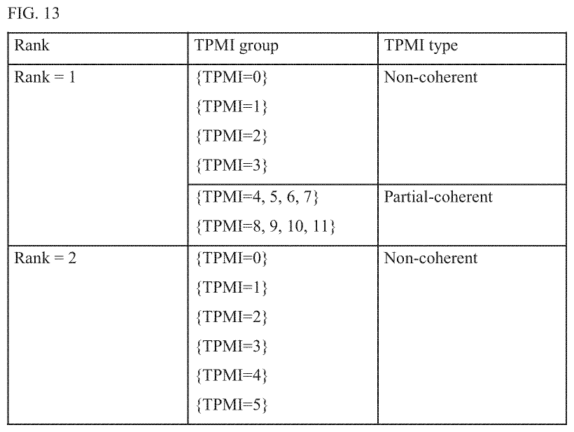

FIG. 13 shows a table of simplified TPMI groups supporting UL full power for 4-Tx Capability 3, partial coherent UE according to one or more embodiments. The table of FIG. 13 is obtained by applying a method of Proposal 5. Thus, the table of FIG. 11 may be simplified based on Proposals 3 or 4.

Configuration of BS

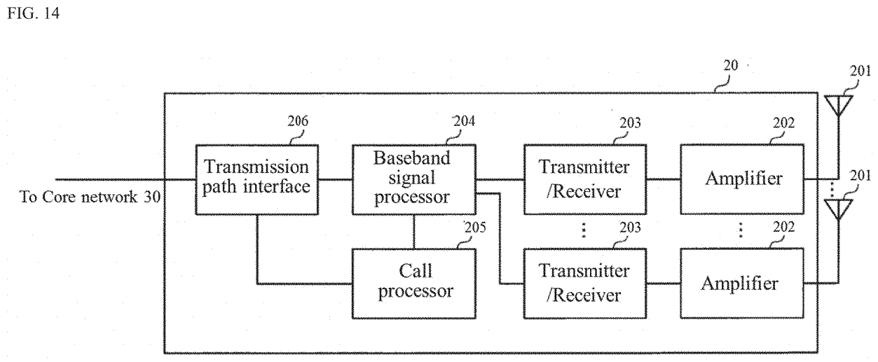

The BS 20 according to embodiments of the present invention will be described below with reference to FIG. 14. FIG. 14 is a diagram illustrating a schematic configuration of the BS 20 according to embodiments of the present invention. The BS 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the BS 20 to the UE 20 is input from the core network, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., Radio Resource Control (RRC) signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the BS 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network through the transmission path interface 206. The call processor 205 performs call processing such as setting up and releasing a communication channel, manages the state of the BS 20, and manages the radio resources.

Configuration of UE

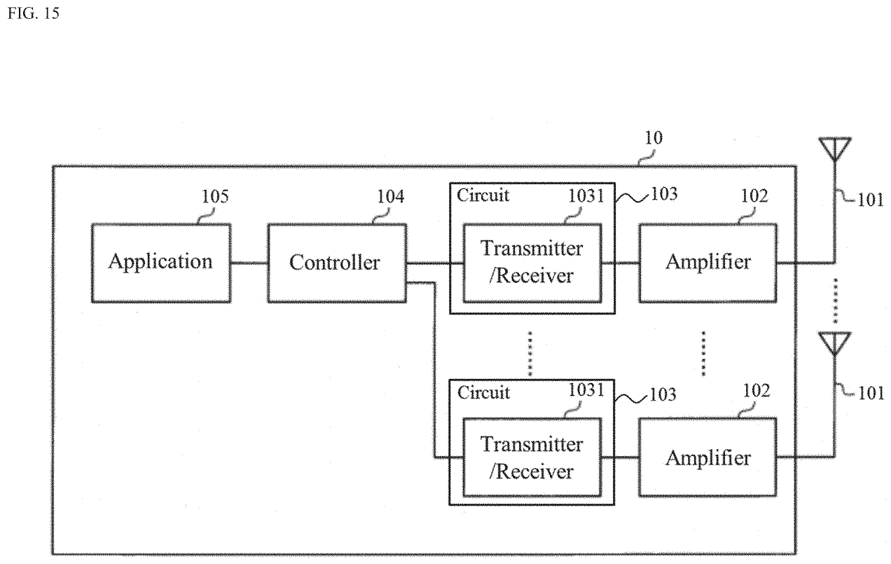

The UE 10 according to embodiments of the present invention will be described below with reference to FIG. 15. FIG. 15 is a schematic configuration of the UE 10 according to embodiments of the present invention. The UE 10 has a plurality of UE antenna S101, amplifiers 102, the circuit 103 comprising transceiver (transmitter/receiver) 1031, the controller 104, and an application 105.

As for DL, radio frequency signals received in the UE antenna S101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

Although the disclosure has been described with respect to only a limited number of embodiments, those skilled in the art, having benefit of this disclosure, will appreciate that various other embodiments may be devised without departing from the scope. Accordingly, the scope of the invention should be limited only by the attached claims.

1. A method of transmission precoding matrix indicator (TPMI) grouping, the method comprising:
identifying all TPMI groups to achieve uplink (UL) full power for partial-coherent user equipment (UE) with 4-Tx ports with a Mode 2 operation; and
transmitting the identified TPMI groups to a base station.

2. The method according to claim 1, wherein the all TPMI groups are identified to achieve UL full power for Rank being 1, 2, 3, or 4.

3. The method according to claim 1, wherein UL full power supporting partial-coherent TPMI groups are identified based on non-coherent TPMI groups for Rank being 1.

4. (canceled)

5. The method according to claim 1, wherein a UL full power supporting non-coherent TPMI group for Rank being 3 is identified based on non-coherent TPMI groups for Rank being 2.

6. The method according to claim 1, wherein a UL full power supporting partial-coherent TPMI group for Rank being 3 is identified based on partial-coherent TPMI groups for Rank being 2.

7. A method of transmission precoding matrix indicator (TPMI) grouping, the method comprising:
identifying only necessary TPMI groups to achieve UL full power for partial-coherent UE with 4-Tx ports with Mode 2 operation; and transmitting the identified TPMI groups to a base station.

8. The method according to claim 1, wherein a UL full power supporting a non-coherent TPMI for Rank being 3 is identified based on non-coherent TPMIs for Rank being 2.

9. The method according to claim 1, wherein the TPMI groups include only non-coherent or partial-coherent TPMIs.

10. The method according to claim 1, wherein in each group of the TPMI groups, all TPMIs of a same Rank in the group are only one of non-coherent or partial-coherent, but not both.

11. The method according to claim 1, wherein if precoders
$$[ \begin{matrix}1 & 0 \\ 0 & 1 \\ 0 & 0 \\ 0 & 0\end{matrix} ] , [ \begin{matrix}1 & 0 \\ 0 & 0 \\ 0 & 1 \\ 0 & 0\end{matrix} ]$$
provide full power for Rank being 2, then precoder
$$[ \begin{matrix}1 & 0 & 0 \\ 0 & 1 & 0 \\ 0 & 0 & 1 \\ 0 & 0 & 0\end{matrix} ]$$
provides full power for Rank being 3.

12. The method according to claim 1, wherein all of the TPMI groups are non-coherent.

13. The method according to claim 1, The method according to claim 1, wherein a UL full power supporting partial-coherent TPMI group for Rank being 3 is identified based on a non-coherent TPMI group for Rank being 2.

14. A partial-coherent user equipment (UE) comprising:
a processor that identifies all transmission precoding matrix indicator (TPMI) groups to achieve uplink (UL) full power with 4-Tx ports with a Mode 2 operation; and
a transmitter that transmits the identified TPMI groups to a base station.
